(19) United States
(12) Patent Application Publication
(10) Pub. No.: US 2003/0169291 A1
(43) Pub. Date: Sep. 11, 2003

(54) Desktop conference method and desktop conference system for performance of semiconductor device process or semiconductor manufacturing apparatus utilizing communication lines

(76) Inventors: Kenji Nakata, Hikari (JP); Koichiro Otani, Kudamatsu (JP); Fumio Shimizu, Tokuyama (JP); Satomi Inoue, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/087,764

(22) Filed: Mar. 5, 2002

(51) Int. Cl. G09G 5/00

(52) U.S. Cl. 345/753

(57) ABSTRACT

A method of conducting a desktop conference comprises a step in which participants of a conference gain access to a desktop conference system by utilizing communication lines; a step in which authentication is made as to whether or not the participants are permitted to gain access; a step in which a list of conference documents describing an evaluation result about a semiconductor device process or semiconductor manufacturing apparatus performance and so worked out as to correspond to the participants is displayed on a display device used by each of the participants; and a step in which the participants select desired one of the conference documents from the list of the conference documents; wherein the participants conduct the desktop conference by using the conference documents.

### BACKGROUND OF THE INVENTION

This invention relates to a desktop conference method and a desktop conference system for performance of semiconductor device process or a semiconductor manufacturing apparatus utilizing a communication system in a semiconductor manufacturing apparatus business.

As an advance activity for selling a semiconductor manufacturing apparatus, it has been necessary for a process engineer of a semiconductor manufacturing apparatus vendor to collect a report evaluating apparatus performance, to pay visit to a semiconductor device manufacturer (client) and to have presentation and a conference with a process engineer of the client. It has also been necessary for the client to visit the vendor and to get explanation.

Progress in high integration and miniaturization technologies of semiconductor devices has recently been accelerated year by year, and the time allowed to develop a process technology of semiconductor manufacturing apparatus and the verification time have unavoidably been reduced. Since the market needs semiconductor devices having higher system performance at a lower cost, manufacturers have to make all possible efforts to reduce the device development cost. It is one of the critical problems under such circumstances how to shorten the verification lead-time of the semiconductor device process and to reduce the cost.

On the other hand, the semiconductor device process attaches much importance to know-how acquired through long experiences. However, the number of clients the experienced process engineer of the vendor can attend is limited. In order for the vendor to attend to a greater number of clients, it is very important how to reduce the number of times of visits of the vendor's process engineer to the client's office and the number of process steps.

### SUMMARY OF THE INVENTION

To solve these problems, it is therefore an object of the invention to provide a desktop conference method and a desktop conference system capable of holding a conference for performance of a semiconductor device process or a semiconductor manufacturing apparatus without the necessity for mutual visits of process engineers of both vendor and client.

The invention employs the following means to accomplish the object described above.

According to one aspect of the invention, there is provided a method of conducting a desktop conference comprising a step in which participants of a conference gain access to a desktop conference system by utilizing communication lines, a step in which authentication is made as to whether or not the participants are permitted to gain access, a step in which a list of conference documents describing an evaluation result about a semiconductor device process or semiconductor manufacturing apparatus performance and so worked out as to correspond to the participants is displayed on a display device used by each of the participants and a step in which the participants select desired one of the conference documents from the list of the conference documents, wherein the participants conduct the desktop conference by using the conference documents.

According to another aspect of the invention, there is provided a desktop conference system in which participants of a desktop conference permitted to gain access from an information terminal equipped with a display device and an input device through communication lines hold the conference on a semiconductor device process or semiconductor manufacturing apparatus performance, wherein a screen of the display device includes an area for displaying dynamic images of counter-part participants, an area for displaying conference documents describing an evaluation result of the semiconductor device process or semiconductor manufacturing apparatus performance, and a chat area capable of preserving a text document inputted as data.

Activity steps of a semiconductor manufacturing apparatus business on the side of a vendor of semiconductor manufacturing apparatuses will be explained. First, development of apparatuses coping with market needs or clients' needs is made. Next, demonstration is made to the client so that the apparatus can acquire a process result of a semiconductor device actually satisfying the clients' needs (process evaluation activity). If the client appreciates performance of the apparatus and places an order in this process evaluation activity, the vendor starts designing and manufacturing steps on the basis of the client's specification. In a subsequent inspection step, quality confirmation of the apparatus is made and the apparatus is shipped to the client. The apparatus is then transported to a semiconductor device manufacturing line of the client and is installed on site. After installation is completed and the client issues an approval, the business steps are completed. However, maintenance and improvements in performance of the apparatus are thereafter made as an after-sale support activity after the apparatus is actually operated.

This invention accomplishes the business steps calling for the conference among the activity steps described above by a desktop conference system using communication lines.

Other objects, features and advantages of the invention will become apparent from the following description of the embodiments of the invention taken in conjunction with the accompanying drawings.

### BRIEF DESCRIPTION OF THE DRAWINGS

FIG. 1 is an overall schematic view of a desktop conference system;

FIG. 2 is a flowchart showing in detail process evaluation activity;

FIG. 3 is a flowchart showing a process evaluation report generation sequence;

FIG. 4 is a flowchart showing a process flow up to the start of WEB publicization;

FIG. 5 shows an example of an evaluation report list;

FIG. 6 is a flowchart showing an access flow to a desktop conference system;

FIG. 7 shows an example of a desktop conference screen;

FIG. 8 is a flowchart showing process steps up to display of a desktop conference screen and display of a booking list of desktop conferences; and

FIG. 9 shows an example of a booking screen of the desktop conference.

### DESCRIPTION OF THE EMBODIMENTS

Preferred embodiments of the invention will be hereinafter explained with reference to the accompanying drawings.

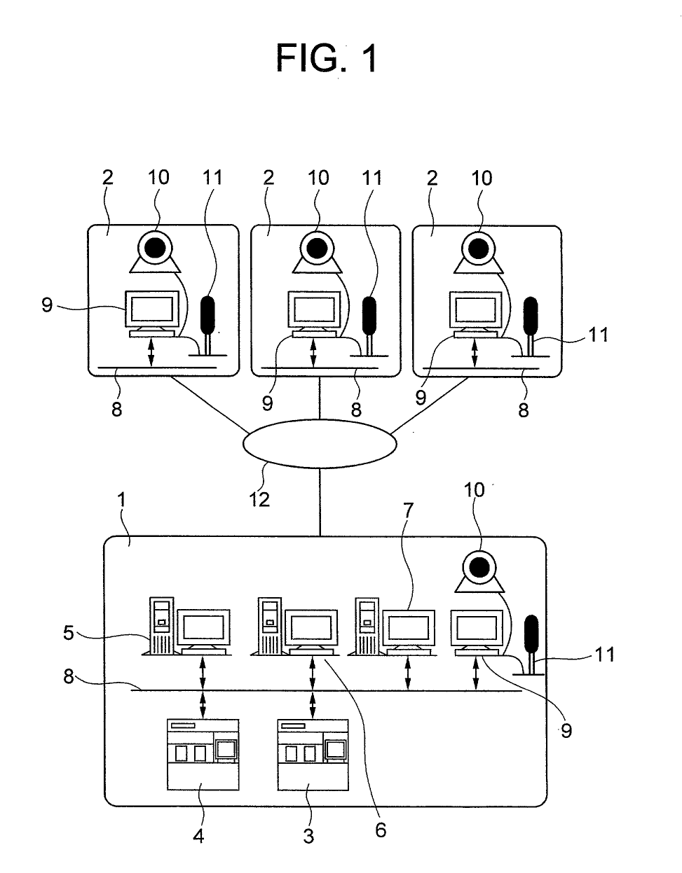

FIG. 1 is an overall schematic view of a desktop conference system for holding a conference on a semiconductor device process or a semiconductor manufacturing apparatus performance utilizing communication lines. Reference numeral 1 denotes an office of a vendor that sells semiconductor manufacturing apparatuses. Reference numeral 2 denotes an office of a semiconductor device manufacturer (client) that purchases the semiconductor manufacturing apparatus and manufactures semiconductor devices. The semiconductor device manufacturer 2 has a plurality of offices at home or abroad.

The vendor has in its office 1 a plurality of semiconductor manufacturing apparatuses 3 such as etching apparatuses, scanning apparatuses, coating-developing apparatuses, etc, and a plurality of measuring equipment 4 for measuring process results of semiconductor devices such as scanning electron microscopes, optical microscopes, film thickness meters, etc. These apparatuses are connected to LAN 8 (Intranet). A server 5 for storing and managing various process results, a desktop conference server 6 and a WEB server 7 for opening information to public on the Internet 12 are also installed in the office 1 and are connected to the LAN 8. Each semiconductor manufacturing apparatus 3 and each measuring equipment 4 exchange various process information by using the server 5 for storing and managing the various process results and a packet communication protocol (TCP/IP). The desktop conference server 6 provides information such as dynamic images, sound, texts, and so forth, to many-to-many personal computers connected to the Internet 12 by using a communication protocol (TCP/IP). The invention will be explained about the case where the desktop conference server 6 is installed in the vendor's office but it may be a desktop conference server provided by a provider as a third party. The WEB server 7 is connected to the Internet 12, executes communication by using an http port and an https port of the communication protocol (TCP/IP) and provides utilization menus of various information to the personal computers connected to the Internet 12. A camera 10 and a microphone 11 are connected to the personal computer 9 to utilize the desktop conference. The personal computer 9 is connected to the LAN 8. The personal computer 9, the server 5 for storing and managing the results of various processes, the desktop conference server 6 and the WEB server 7 communicate the process evaluation information and the dynamic images and sound for the desktop conference by using the packet communication protocol (TCP/IP).

Each semiconductor device manufacture (client) has in its office 2 a personal computer 9 connected to a camera 10 and a microphone 11. It is sufficient in this case if the personal computer 9 can be connected to the Internet 12 through the LAN 8.

In the desktop conference system according to the invention, the client need not at all have any complicated system. Therefore, a burden to the client is not great. When the client's personal computer is merely connected to the vendor's WEB server 7 and to the desktop conference server 6 by using the browser, the client can acquire the dynamic images and sound for the desktop conference and the evaluation documents of various device processes displayed on the screen.

Next, the process evaluation activity will be explained in detail.

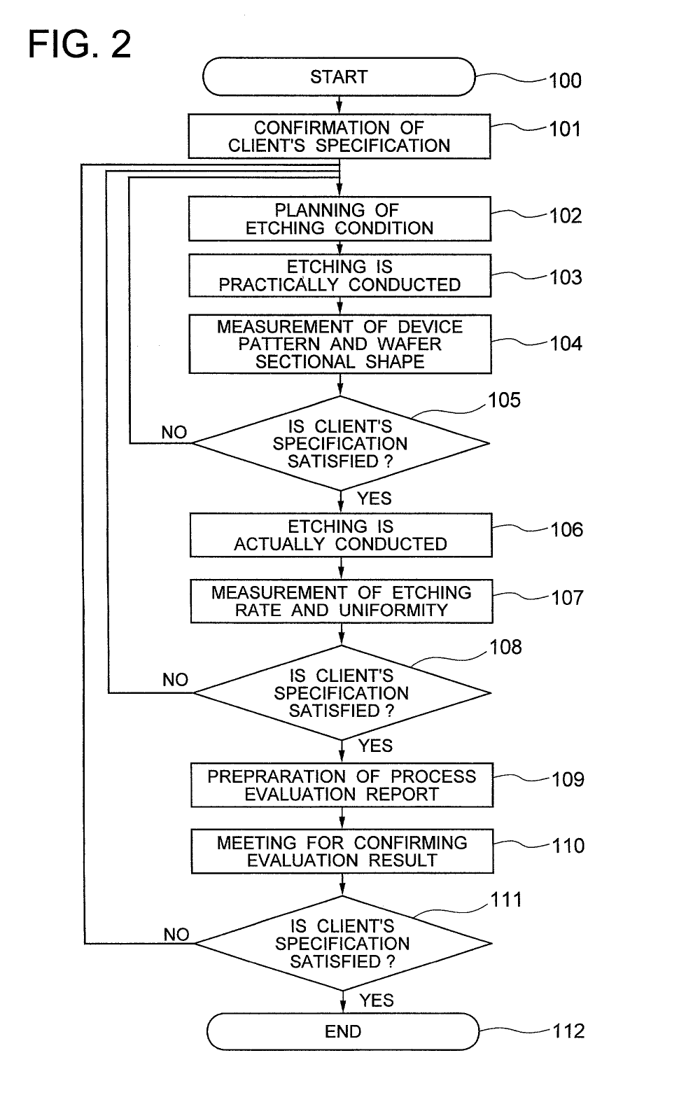

FIG. 2 shows a flow of the process evaluation activity of an etching apparatus as one of the semiconductor manufacturing apparatuses by way of example. First, a process engineer of the vendor holds a conference with the client and confirms a client's specification such as a device pattern and etching characteristics such as a sectional shape (Step 101). Next, the process engineer plans an etching condition for satisfying the required client's specification such as an etching rate, a gas kind, a gas flow rate, and so forth (Step 102). The etching condition so planned is set to an apparatus owned by the vendor, and a sample wafer supplied by the client is actually etched (Step 103). Next, the device pattern of the sample wafer so etched and the shape of the section of the wafer are measured by using measuring equipment such as SEM (Scanning Electron Microscope) or an optical microscope (Step 104). Whether or not the process result obtained satisfies the client's specification is then evaluated (Step 105). When the result proves NO, the etching condition is again planned and evaluation is repeated time and time again until the client's specification is satisfied. When the process results satisfy the client's specification, the sample wafer is again etched actually under the same etching condition so as to measure other etching characteristics such as etching uniformity inside the wafer and the etching rate (Step 106). Next, the sample wafer etched is measured by using a film thickness meter and a displacement-measuring instrument (Step 107). Here, the etching condition is also reviewed and evaluated again and again until the client specification is satisfied as described above.

Generally, the richer in experience the process engineer is, the shorter becomes the time for the process engineer to find out the etching condition satisfying the client's request. In other words, observing the process result obtained by a certain etching condition, the process engineer can judge through his experiences which etching condition is to be next changed to which extent so as to approach to the client's specification.

The process engineer of the vendor then works out a result report summary reporting the result of the process evaluation activity described above and a process evaluation report including a detailed data sheet that summarizes the measurement result obtained by the evaluation activity (Step 109). The process engineer holds the evaluation result confirmation conference with the client on the basis of this process evaluation report (Step 110). When the client is not satisfied in this conference, setting and evaluation of the etching condition are repeated time and time again.

As explained above, the conference must be held many times with the client in the semiconductor manufacturing apparatus business until the client's specification is satisfied, and the process engineer must pay visit each time to the client. Therefore, the time and the cost can be reduced if this conference can be efficiently made. If the client is abroad, this effect becomes enormous.

Next, the process evaluation report will be explained in detail.

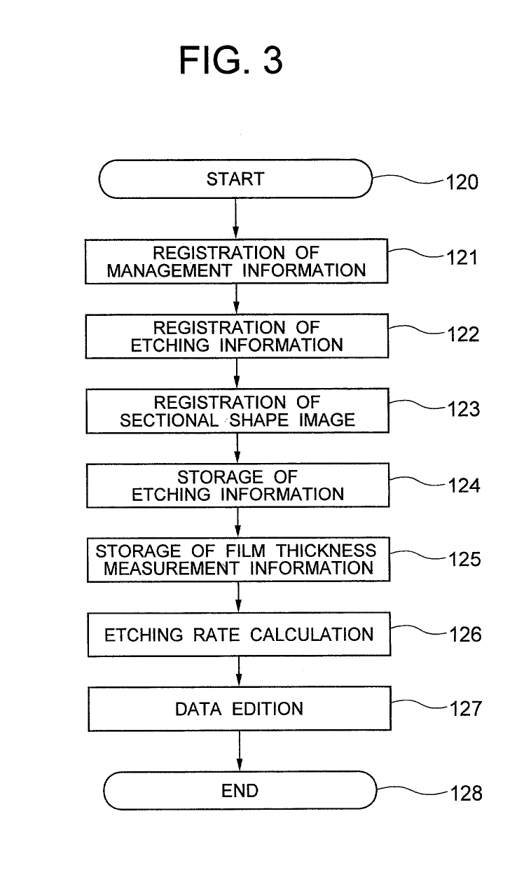

FIG. 3 shows an example of a generation sequence of the process evaluation report. First, the process engineer of the vendor registers the management information for each process evaluation such as a client's number and a project number for each client's specification to the database of the server for storing and managing various process results (Step 121). Next, etching information to be processed under a certain etching condition, e.g. etching condition, end point judgment information, apparatus condition such as temperature, processing time, etc, are registered to the database in association with the management information for each process evaluation described above (Step 122). The sectional shape of the wafer after etching is measured, and the electronic image of the measurement result is registered to the database in association with the management information for each process evaluation (Step 123). The data such as film thickness measurement information obtained by the film thickness meter and the displacement-measuring instrument is stored (Step 125), and the computation result of uniformity inside the wafer and the etching rate are also registered to the database in association with the management information (Step 126). In addition, the process evaluation activity step and its progress condition, the report completion signature for setting whether or not the process evaluation report is completed and the WEB publicization signature for setting whether or not the process evaluation report completed is to be open to public on the WEB are registered to the server 5 for storing and managing various process results. The process engineer confirms and edits each of the data so registered (Step 127) and completes a series of process evaluation reports.

The detailed data sheets of the process evaluation report are as follows:

(1) a process data sheet describing etching condition values for each sample wafer as a list and generated for the purpose of confirming with the client setting of the etching apparatus satisfying the client's specification and the optimum condition from among a plurality of condition setting;

(2) an SEM measurement sheet generated for the purpose of comparatively examining the sectional shape of the sample wafer processed under each etching condition through images; and

(3) a process rate sheet generated for the purpose of confirming uniformity of the etching depth in each sample wafer, the etching rate, the selection ratio of etching portions to non-etching portions, etc.

It is advisable in this instance to display the associated detailed data sheet or sheets in a window separate from the window of the result report summary so that they can be quickly looked up when the row representing the etching condition on the page of the result report summary is clicked, for example. Alternatively, a hyper-link of the detailed data sheet may be set to a predetermined position of a later-appearing desktop conference screen.

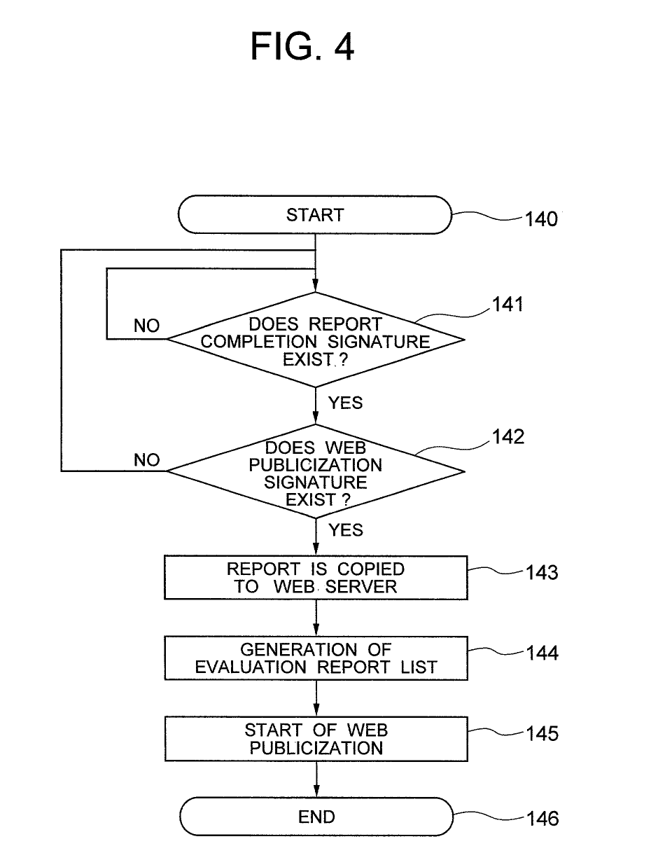

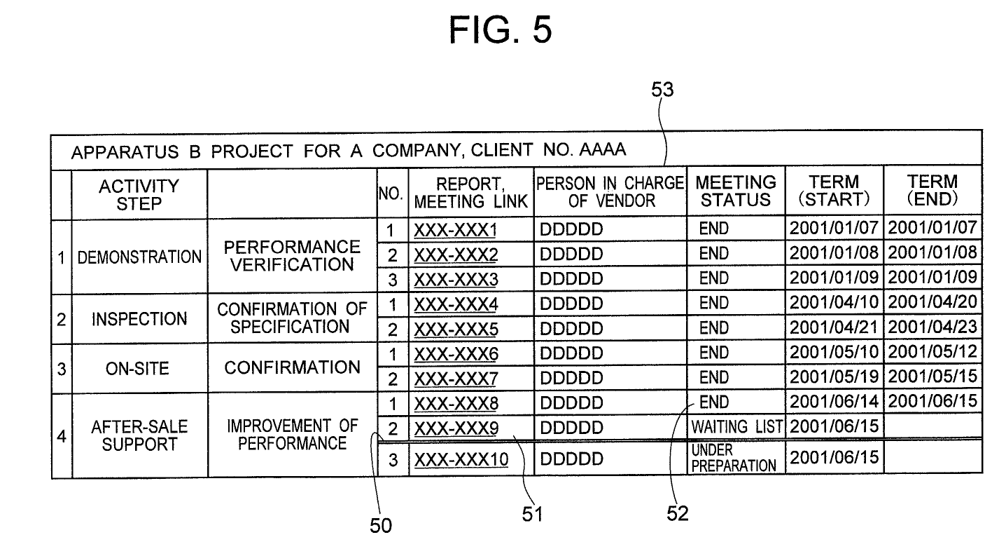

FIG. 4 shows a flow from completion of the generation of the process evaluation report to the start of publicization on the WEB. When the process evaluation report completion signature is registered (Step 141), whether or not the WEB publicization permission signature of the management information for each process evaluation is set is judged (Step 142). When the WEB publicization permission signature is set, the process evaluation report is copied from the server 5 storing and managing the process results to the WEB server 7 (Step 143). When the process evaluation report is copied, one row 50 of the evaluation report list shown in FIG. 5 is generated in conformity with the process evaluation activity step recorded to the management information (Step 144). As one row 50 is generated in the evaluation report list, opening of the information to public on the WEB becomes possible (Step 145).

Since the evaluation report list shown in FIG. 5 step-wise arranges the semiconductor manufacturing sales business, the process engineers of both vendor and client can clearly know in which process step the present activity step exists.

One row 50 of the evaluation report list represents the management number of the specification for each client, and the hyper-link 51 to the process evaluation report is set. A sign 52 of “waiting list” is set to the column of the conference condition. A sign “end” is set when the conference is over.

During the period in which the process evaluation report is registered to the WEB server, that is, while the column of the conference condition is set to the “waiting list” or to the “end”, the participant can check at an arbitrary time the process evaluation report. In other words, the participant can know the evaluation result the instant the process evaluation result is opened to public on the WEB server, that is, very quickly, irrespective of the date of the conference. Since the conference can be held while the participants look over in advance the process evaluation report, the conference can be densely made. Further, since it is also possible to check the past process evaluation report, comparative studies can be very effectively made.

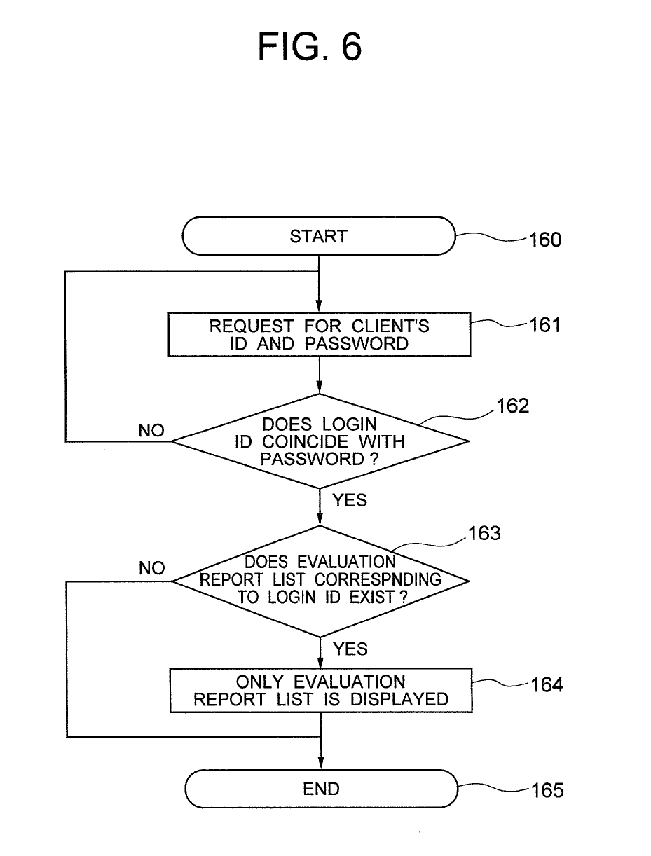

FIG. 6 shows a flow of a security process when the client gains access to the desktop conference system according to the invention by utilizing the Internet 12. First, the security process requires each client to input a login ID and a password allotted to the client (Step 161). Next, whether or not the login ID and the password are coincident is judged (Step 162). Whether or not the list of the client management number corresponding to the login ID exists is judged (Step 163). When the evaluation report list 53 exists, only this evaluation report list is displayed (Step 164). According to this system configuration, it is possible to prevent the access of the third party other than the clients permitted to participate in the conference and to display only the evaluation report list corresponding to the login ID of the client. It is thus possible to secure information security of each client.

Communication when the client gains access to the WEB server 7 by utilizing the browser of the personal computer is made through packet communication using communication means subjected to cipher-complex processing so as to improve security on the Internet 12.

On the other hand, the process engineers of the vendor can share the information inside the office because they are allowed to utilize the evaluation report list 53 of all the clients, whenever necessary, irrespective of each login ID.

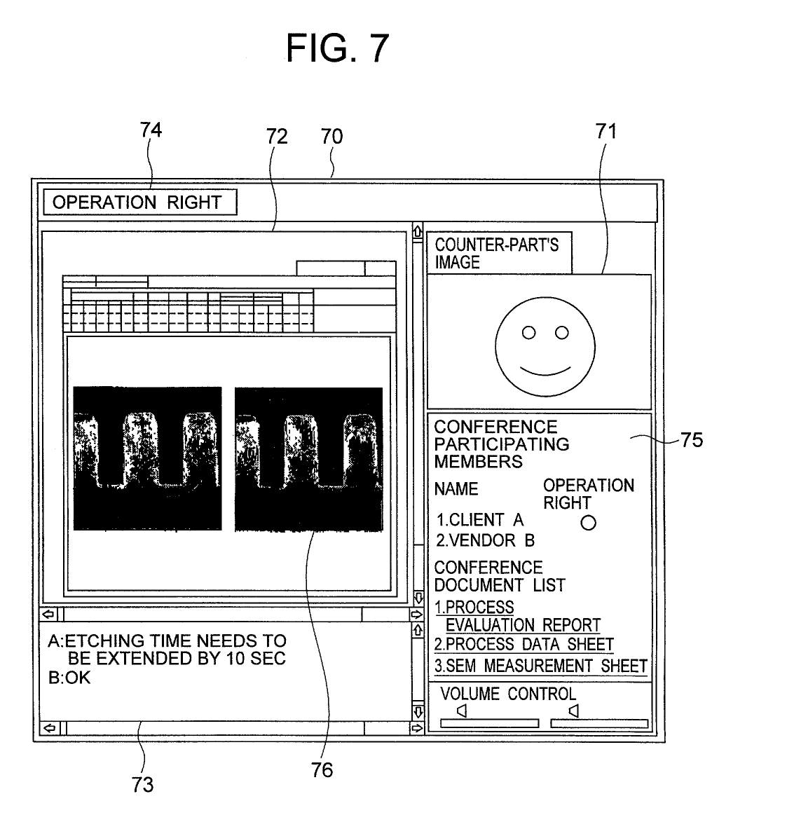

FIG. 7 shows an example of a desktop conference screen. The screen 70 includes a dynamic image area 71 for displaying a dynamic image taken by a camera 10 of a communication counter-part, a document display area 72 for displaying information necessary for the conference, a chat area 73 for displaying on the real time basis a text of the content of the conference, an operation right button 74 so disposed as to prevent competition of the screen operation and an information area 75 for listing up the documents that are to be used in the desktop conference. Since this conference document list, too, has the hyper-link for display to the document display area 72, the conference can be carried while the associated detailed data sheet is displayed on the document display area 72 when the sheet is clicked, whenever necessary. However, the documents may be displayed by opening another window. Because marking can be made by line graphics or characters at arbitrary positions on the document displayed, it is possible to clarify which portion of the etching shape, for example, is now explained.

The text document inputted to the chat area 73 can be stored as the data. After the conference is over, the text document can be distributed by E-mail to those concerned other than the participants of the conference.

The speech of the participants of the conference can be inputted through the microphone and can be displayed as the text document in the chat area through a speech-character conversion function.

The speech of the participant inputted from the microphone 11 can be preserved as the electronic data.

Because those displayed on the desktop conference screen 70 can be recorded and reproduced, the conference can be reproduced at any time by preserving them as the electronic data with the speech inputted through the microphone 11.

The speech inputted through the microphone 11 is outputted from the speakers or headphones of both parties through communication lines. Streaming technology is preferably employed to exchange the dynamic images and the speech.

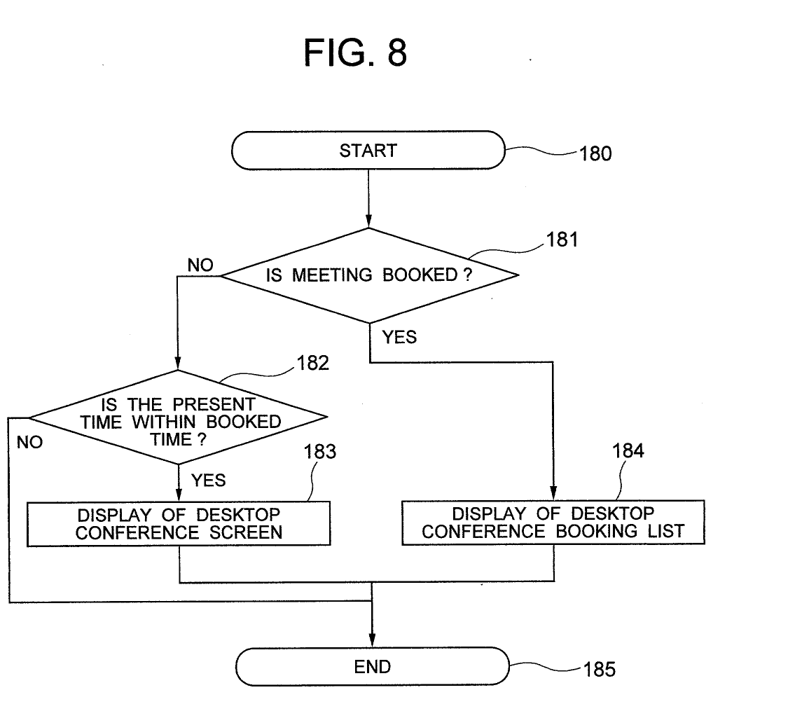

FIG. 8 shows the process steps up to the screen display of the desktop conference and the process steps up to the booking screen display of the desktop conference. In the desktop conference system according to the invention, a desktop conference room is set for each report corresponding to the management number of the client and for each conference link 51. When the report inside the evaluation report list 53 and the conference link 51 are clicked after the evaluation report list 53 is displayed through the authentication steps represented by Steps 161 to 164 in FIG. 6, the desktop conference system judges whether or not a conference status column 52 of the evaluation report list 53 is the “waiting list” (Step 181). When it is the “waiting list” and booking is not yet established, the desktop conference booking list is displayed (Step 184). When the conference status column 52 is the “booked”, whether or not the present date and time are within the date fixed for the conference is judged (Step 182). When they are, the desktop conference screen 70 is displayed (Step 183).

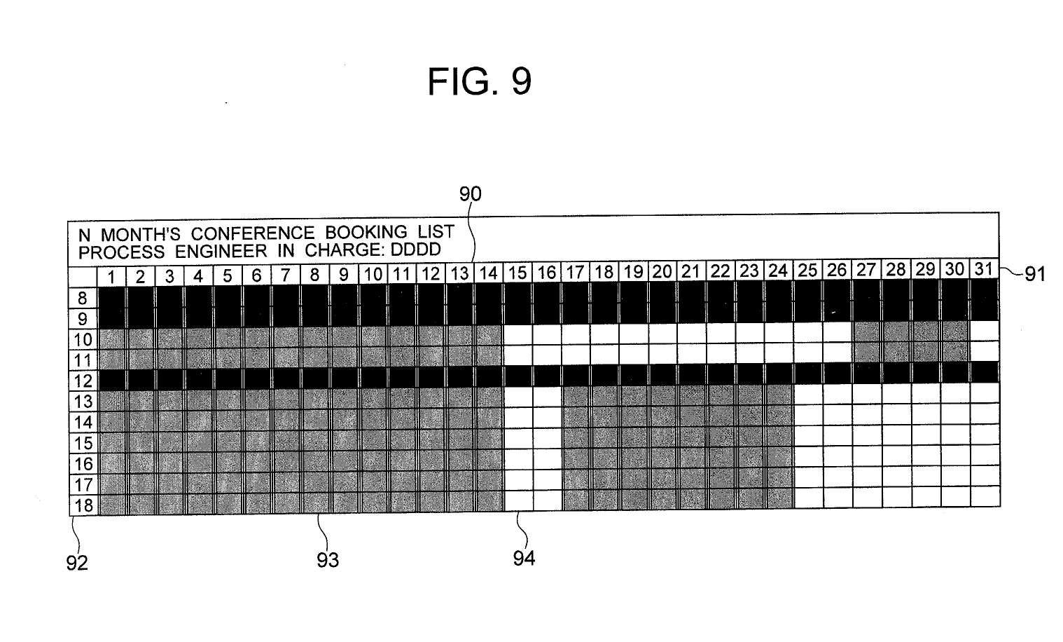

FIG. 9 shows an example of the booking screen of the desktop conference. A conference booking list 90 displayed on the booking screen is generated for each person in charge in the vendor described in the evaluation report list 53. Reference numeral 91 denotes the date and reference numeral 92 does the time. Half tone cells 93 inside the screen represent a booking time zone or a time zone that cannot be attended. Blank cells 94 represent a time zone that can be attended. The process engineer of the client can book the desktop conference by clicking an arbitrary blank cell 94 of the conference booking list 90. When the desktop conference is thus booked, the conference status column 52 of the evaluation report list is set to “booked”.

When booking of the desktop conference is made, the E-mail of the notice of the conference is automatically distributed to the process engineers of both vendor and client. This E-mail of the notice of the conference is again distributed automatically at a predetermined time before the starting time of the conference.

To commence the desktop conference, the client first connects the information terminal 9 such as the personal computer to the public WEB server 7 of the vendor by using the Internet browser through the authentication steps described above. After connection is established, the evaluation report list 53 for each client is displayed on the screen. Therefore, the client then clicks a desired conference link 51 from among the list so displayed. Consequently, the desktop conference screen 70 of the booked desktop conference server 6 is displayed with the process evaluation report. The process engineer of the vendor likewise displays the desktop conference screen 70 and the process evaluation report and communication can now be made. The conference is carried while the associated data sheet link is arbitrarily clicked, whenever necessary, to display the explanatory document on the document display area 72.

The desktop conference method and the desktop conference system according to the invention are not particularly limited to the embodiment given above. Next, another embodiment of the invention will be explained.

The office 1 of the vendor of the semiconductor manufacturing apparatus may be a contractor for manufacturing a semiconductor device (hereinafter called the “manufacturer”) and the office 2 of the semiconductor device manufacturer (client) may be a semiconductor device circuit design company (hereinafter called the “design company”) not having a semiconductor manufacturing line, for example. The design company requests the manufacturer to manufacture a semiconductor device developed by its own company. Receiving the request, the manufacturer actually manufactures the semiconductor device and evaluates the semiconductor device itself. In the development process of the semiconductor device, evaluation is made again and again until required device performance such as an arithmetic operation, an operating frequency, a processing speed, an operating voltage, power consumption, etc, can be acquired as designed. The conference can be carried on quickly and at a low cost on the basis of the evaluation result by utilizing the desktop conference method and desktop conference system described above. The manufacturer can charge the utilization fee or the consulting fee in compensation for the manufacture of the semiconductor device or in accordance with the utilization time of the desktop conference system. On the other hand, the design company can feed back the actual manufacturing result and the evaluation result of the semiconductor device to a circuit designer in addition to the simulation result of the circuit design without the necessity for keeping its own semiconductor manufacturing line, and can develop a better semiconductor device within a shorter period of time.

According to the invention described above, the process engineers of both vendor and client can quickly and economically carry on the conference on the semiconductor device process or on performance of the semiconductor manufacturing apparatus by utilizing the desktop conference system using the communication lines while sequentially checking the sound, the image and the text documents or the expression of the counterpart without the need for paying visit to each other. Therefore, the conference equivalent to the one actually called by mutual visits of the process engineers can be carried quickly and economically.

According to the invention, the time for the business trip for the conference can be reduced, and the experienced process engineers of the vendor can attend to a greater number of clients. In other words, the vendor can propose an optimal process condition within a shorter time and can improve client's satisfaction. Therefore, the vendor can expand a business chance as the semiconductor manufacturing apparatus vendor.

It should be further understood by those skilled in the art that the foregoing description has been made on embodiments of the invention and that various changes and modifications may be made in the invention without departing from the spirit of the invention and the scope of the appended claims.

What is claimed is:

1. A method of conducting a desktop conference comprising:
a step in which participants of a conference gain access to a desktop conference system by utilizing communication lines;
a step in which authentication is made as to whether or not said participants are permitted to gain access;
a step in which a list of conference documents describing an evaluation result about a semiconductor device process or semiconductor manufacturing apparatus performance and so worked out as to correspond to said participants is displayed on a display device used by each of said participants; and
a step in which said participants select desired one of said conference documents from said list of said conference documents;
wherein said participants conduct the desktop conference by using said conference documents.

2. A method of conducting a desktop conference according to claim 1, wherein said list describing the evaluation result about said semiconductor device process or said semiconductor manufacturing apparatus performance is arranged in order of activity steps of a semiconductor manufacturing apparatus sales business.

3. A method of conducting a desktop conference according to claim 1, which further comprises a step of displaying a screen for said desktop conference on said display device if booking of the desktop conference has been made, after said step of selecting said conference documents.

4. A method of conducting a desktop conference according to claim 1, which further comprises a step of displaying a desktop conference booking list if booking of the desktop conference has not been made, after said step of selecting said conference documents, and a step of allowing said participants to select the date and the time of the desktop conference from among said desktop conference booking list.

5. A method of conducting a desktop conference according to claim 4, which distributes an electronic mail of a notice of fixture of the desktop conference to said participants when booking of the desktop conference is established.

6. A desktop conference system in which participants of a desktop conference permitted to gain access from an information terminal equipped with a display device and an input device through communication lines hold the conference on a semiconductor device process or semiconductor manufacturing apparatus performance, wherein a screen of said display device includes an area for displaying dynamic images of counter-part participants, an area for displaying conference documents describing an evaluation result of the semiconductor device process or semiconductor manufacturing apparatus performance, and a chat area capable of preserving a text document inputted as data.

7. A desktop conference system according to claim 6, wherein the screen of said display device further includes an area for displaying a conference document list describing an evaluation result of the semiconductor device process or semiconductor manufacturing apparatus performance, and has a hyper-link bonded thereto.

8. A desktop conference system according to claim 6, wherein, when said hyper-link is clicked, said conference document corresponding to said hyper-link is displayed on a screen separate from the screen that has already been displayed.

9. A desktop conference system according to claim 6, which has a function of distributing the text document data inputted to, and preserved in, said chat area through an electronic mail.

10. A desktop conference system according to claim 6, which has a function of marking an arbitrary position of said conference document.

11. A desktop conference system according to claim 6, which inputs speech of said conference participants through a microphone and displays the speech as a text document on said chat area through a speech-character conversion function.

12. A desktop conference system according to claim 6, which has a function of preserving contents of the speech of the participants as speech data of the participants.

13. A desktop conference system according to claim 6, which has a function of recording and reproducing the contents displayed on the screen of said display device.

14. A desktop conference system according to claim 6, which has a function of charging a fee for said desktop conference system in accordance with the utilization time.
